(19) United States
(12) Patent Application Publication
(10) Pub. No.: US 2025/0371385 A1
(43) Pub. Date: Dec. 4, 2025

(54) EQUALIZERS WITH INFERENCE

(71) Applicant: SAMSUNG ELECTRONICS CO., LTD., Suwon-si (KR)

(72) Inventors: Dongmin Ko, Suwon-si (KR); Hanseok Kim, Seoul (KR); Wooseok Choi, Seoul (KR); Youngdon Choi, Suwon-si (KR)

(73) Assignee: Seoul National University R&DB Foundation, Seoul (KR)

(21) Appl. No.: 18/961,131

(22) Filed: Nov. 26, 2024

(30) Foreign Application Priority Data
Jun. 4, 2024 (KR) 10-2024-0073181

(51) Int. Cl. G06N 5/04

(52) U.S. Cl. CPC G06N 5/04

(57) ABSTRACT

An equalizer, an operating method of the equalizer, and a receiver including the equalizer are provided. An equalizer including an artificial neural network (ANN) structure includes a buffer circuit configured to store samples sequentially input thereto and provide forward data and backward data, a forward pass circuit configured to generate a forward output by performing inference from the forward data in a feedforward manner according to an order in which the samples are input, a backward pass circuit configured to generate a backward output by performing inference from the backward data in a feedback manner in a reverse order to the order in which the samples are input, and a merging circuit configured to generate equalized output data, based on the forward output and the backward output.

### CROSS-REFERENCE TO RELATED APPLICATION

This application claims priority under 35 U.S.C. § 119 to Korean Patent Application No. 10-2024-0073181, filed on Jun. 4, 2024, in the Korean Intellectual Property Office, the disclosure of which is incorporated by reference herein in its entirety.

### BACKGROUND

With advancements in data technology, a vast number of data signals need to be transmitted and received between devices, and interfacing technology may be used to facilitate this. Devices may be connected through channels which carry data signals. However, due to various factors such as skin effect, dielectric loss, etc., data signals transmitted through a channel may contain intersymbol interference (ISI) or other noise, and data signals transmitted at high speeds may be distorted. To compensate for such signal distortion, an interface may include an equalizer. For high-speed communication, an equalizer may compensate for signal distortion while filtering signals at high speeds.

### SUMMARY

Some aspects of this disclosure provide equalizers including an artificial neural network (ANN) structure for improving the quality of data signals transmitted or received between devices. Also described herein are operating methods of the equalizers, and receivers including the equalizers.

According to some implementations, an equalizer including an ANN structure includes a buffer circuit configured to store samples sequentially input thereto and provide forward data and backward data, a forward pass circuit configured to generate a forward output by performing inference from the forward data in a feedforward manner according to an order in which the samples are input, a backward pass circuit configured to generate a backward output by performing inference from the backward data in a feedback manner in a reverse order to the order in which the samples are input, and a merging circuit configured to generate equalized output data, based on the forward output and the backward output.

According to some implementations, an operating method of an equalizer including an ANN structure includes sequentially receiving samples that are in a digital form from an analog-to-digital converter, storing the samples and providing forward data and backward data, generating a forward output by performing inference from the forward data in a feedforward manner according to an order in which the samples are input, generating a backward output by performing inference from the backward data in a feedback manner in a reverse order to the order in which the samples are input, and generating equalized output data, based on the forward output and the backward output.

According to some implementations, a receiver includes an input amplifier configured to amplify an input signal and output an amplified input signal, an analog-to-digital converter configured to sequentially generate samples that are in a digital form from the amplified input signal, and an equalizer including an ANN structure and configured to generate equalized output data based on the samples sequentially input, wherein the equalizer may be configured to store the samples and provide forward data and backward data, generate a forward output by performing inference from the forward data in a feedforward manner according to an order in which the samples are input, generate a backward output by performing inference from the backward data in a feedback manner in a reverse order to the order in which the samples are input, receive consecutive first and second signals constituting input data, the equalizer including a first layer and a second layer respectively corresponding to the first signal and the second signal, and generate equalized output data, based on the forward output and the backward output.

### BRIEF DESCRIPTION OF THE DRAWINGS

Implementations according to this disclosure will be more clearly understood from the following detailed description taken in conjunction with the accompanying drawings in which:

FIG. 1 is a block diagram of a communication system according to some implementations;

FIG. 2 is a diagram illustrating signals input to a receiver, according to some implementations;

FIG. 3 is a block diagram of an equalizer according to some implementations;

FIGS. 4A and 4B are diagrams illustrating input data input to an equalizer, according to some implementations;

FIG. 5 is a diagram illustrating an artificial neural network (ANN) structure within an equalizer, according to some implementations;

FIG. 6 is a diagram illustrating an ANN structure within an equalizer, according to some implementations;

FIG. 7 is a diagram illustrating an ANN structure within an equalizer, according to some implementations;

FIG. 8 is a flowchart of an operating method of an equalizer, according to some implementations;

FIG. 9 is a block diagram of a system including an equalizer, according to some implementations;

FIG. 10 is a block diagram of a system-on-chip (SoC) including an equalizer, according to some implementations;

FIG. 11 is a block diagram of a system including an equalizer, according to some implementations; and

FIG. 12 illustrates a memory device including or associated with an equalizer, according to some implementations.

### DETAILED DESCRIPTION

Hereinafter, examples will be described in detail with reference to the attached drawings.

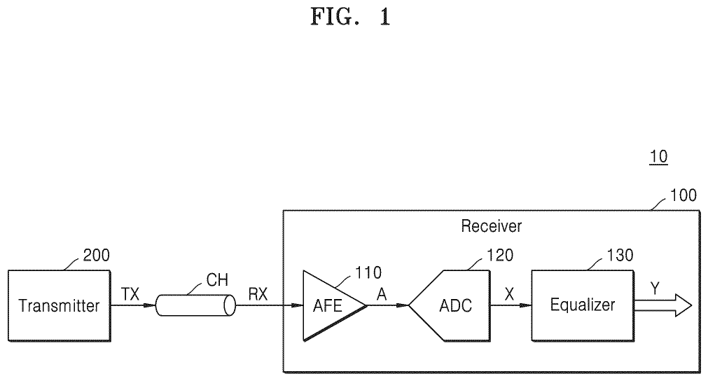

FIG. 1 is a block diagram of a communication system 10. The communication system 10 includes a receiver 100 that may communicate with a transmitter 200 over a channel (e.g., a communication channel or link) CH.

The transmitter 200 and the receiver 100 may refer to any objects that communicate with each other via the channel CH. For example, the transmitter 200 and the receiver 100 may be integrated circuits manufactured through semiconductor manufacturing processes and may be included together in one package or separately in different packages. Furthermore, the transmitter 200 and the receiver 100 may be included in a single system or may be respectively included in separate systems connected via the channel CH.

The channel CH may refer to any medium through which a signal is transmitted. For example, the channel CH may include a cable for transmitting electrical signals, optical signals, etc., and/or may include patterns formed on an integrated circuit or a printed circuit board (PCB). In some implementations, the channel CH may be a serial communication channel and may include differential signals or clock signals.

The transmitter 200 may output a transmission signal TX including information to the receiver 100 via the channel CH. For example, the transmitter 200 may encode information to be transmitted to the receiver 100, e.g., payload data, and generate a transmission signal TX by modulating the encoded data. The transmitter 200 may employ any modulation scheme and may use higher-order modulation, such as multi-level signaling, for high data rates. The transmission signal TX may include a series of symbols (or data symbols), and information may be represented by a value of a symbol, e.g., a symbol value.

In some implementations, the transmitter 200 may transmit the transmission signal TX by using an N-level pulse amplitude modulation (PAM-N) scheme (e.g., a PAM-N signaling scheme, a PAM-N decoding scheme, a PAM-N mode, and/or the like), where N is an integer greater than or equal to 3. In this case, the transmission signal TX may have one voltage level among N different voltage levels generated for PAM-N. In a 4-level PAM (PAM-4) scheme, the transmitter 200 may transmit a transmission signal TX having any one of four voltage levels to the receiver 100. The four voltage levels may respectively correspond to first to fourth logic values (e.g., bit values) (e.g., ‘00’ (=00b), ‘01’ (=01b), ‘10’ (=10b), ‘and 11’ (=11b)), but are not limited thereto. According to various schemes such as 8-level PAM (PAM-8) and 16-level (PAM-16), the transmission signal TX may have any one of 8 or 16 voltage levels. Furthermore, in some implementations, the transmitter 200 may transmit the transmission signal TX to the receiver 100 by using a non-return-to zero (NRZ) scheme, e.g., by including a 1-bit symbol corresponding to two levels.

The channel CH may attenuate the high-frequency contents of high-speed random data due to skin effect, dielectric loss, etc. For example, the transmission signal TX transmitted via the channel CH may experience channel loss. Furthermore, the channel CH may cause impedance discontinuities (mismatches) due to connectors and other physical interfaces between boards and cables. In addition, each bit of data passing through the channel CH may interfere with the next bit due to channel loss or bandwidth limitations, and intersymbol interference (ISI) may occur between data bits, which is a phenomenon in which neighboring symbols overlap and thus a bit error rate (BER) increases. Due to at least the above-described phenomena caused by the channel CH, the transmission signal TX may be distorted as the transmission signal TX passes through the channel CH, and accordingly, the receiver 100 may receive a reception signal RX that is different from the transmission signal TX.

In order to compensate for signal distortion incurred due to the channel CH, the transmitter 200 and/or the receiver 100 may include a structure for channel equalization. For example, the transmitter 200 may initialize a connection to the receiver 100 and perform channel training (or link training) during the initialization process. In channel training, the transmitter 200 may transmit a symbol stream including a predefined series of symbols to the receiver 100, and the receiver 100 may calculate parameters representing characteristics of the channel CH by sampling the symbol stream and may provide the calculated parameters to the transmitter 200. The transmitter 200 may provide parameters for processing a reception signal RX to the receiver 100 based on the calculated parameters provided from the receiver 100 and may generate a transmission signal TX processed based on the parameters provided from the receiver 100 upon completion of the channel training.

The receiver 100 may receive a reception signal RX via the channel CH and may perform channel equalization by processing the reception signal RX based on the parameters provided from the transmitter 200. Referring to FIG. 1, the receiver 100 may include an analog front-end (AFE) circuit 110, an analog-to-digital converter (ADC) 120 (e.g., an ADC circuit), and an equalizer 130 (e.g., an equalizer circuit).

The AFE circuit 110 may receive the reception signal RX through the channel CH and output an analog input signal A to the ADC 120. For example, the AFE circuit 110 may generate the analog input signal A by amplifying the reception signal RX. The AFE circuit 110 may also be referred to herein as an input amplifier.

The ADC 120 may receive the analog input signal A from the AFE circuit 110 and convert the analog input signal A into a digital input signal X. The ADC 120 may have a sampling rate and resolution required to generate output data Y in the equalizer 130. The digital input signal X may be simply referred to herein as input data X.

The equalizer 130 may receive the input data X from the ADC 120 and generate equalized output data Y based on the input data X. The equalizer 130 may compensate for a signal distorted due to the phenomena associated with the channel CH described above. For example, the equalizer 130 may compensate for distortion in the distorted reception signal RX to reduce a BER and improve ISI. The equalizer 130 may also be referred to as an equalization circuit.

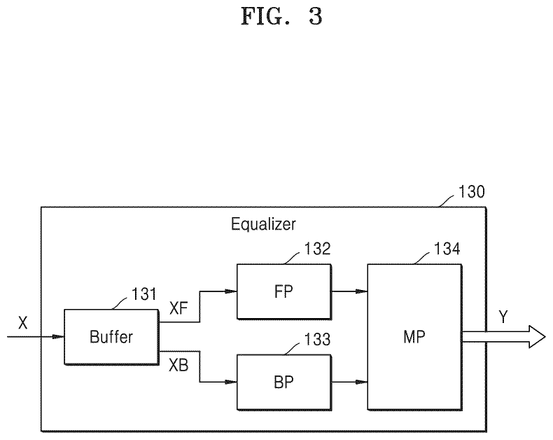

In some implementations, the equalizer 130 may be configured to include an artificial neural network (ANN) structure. For example, the equalizer 130 may include a plurality of artificial intelligence (AI) layers, each including of a plurality of processing elements (PEs). A PE may be referred to herein as a processing unit. A specific example of the equalizer 130 is described in detail below with reference to FIGS. 3, 6, and 7.

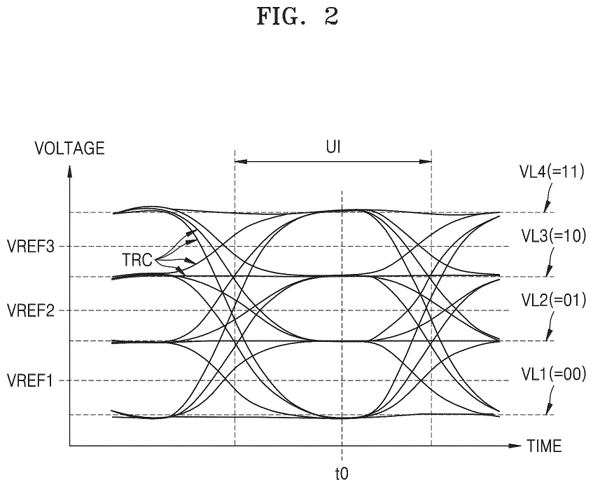

FIG. 2 is a diagram illustrating signals input to a receiver, according to some implementations. In this example, FIG. 2 illustrates examples of symbols modulated using PAM-4. The vertical axis of FIG. 2 represents voltage. Referring to FIG. 2, waveforms generated by superimposing bits of data transmitted serially may resemble the shape of an eye. These waveforms may be referred to as an eye diagram.

To generate an eye diagram, an oscilloscope or another computing device may sample a reception signal RX over a unit interval (UI) (e.g., a sample period or a bit period). A UI may be defined by a clock signal associated with transmission of the reception signal RX. The oscilloscope or other computing device may form a plurality of traces TRC by measuring a voltage level of the reception signal RX during the UI. By overlaying a plurality of traces TRC, various characteristics of the reception signal RX may be determined.

Eye diagrams may be used to identify a number of signal characteristics such as jitter, crosstalk, signal loss, signal-to-noise ratio (SNR), and other characteristics. A slope of a trace TRC during a rise time or falling time may indicate sensitivity of the reception signal RX to a timing error. Jitter that is a timing error due to misalignment of rise and falling times may occur when a rising or falling edge happens at a different time than an ideal time defined by a data clock and may be caused by signal reflections, ISI, crosstalk, process-voltage-temperature (PVT) variations, random jitter, additive noise, or a combination of these.

A symbol may have a level corresponding to a symbol value in a UI. For example, a symbol may have any one of first to fourth voltage levels VL1 to VL4 in the UI, and the first to fourth voltage levels VL1 to VL4 may respectively correspond to four different symbol values (e.g., binary numbers “00”, “01”, “10”, and “11”). The first voltage level VL1 may be lower than the second voltage level VL2, the second voltage level VL2 may be lower than the third voltage level VL3, and the third voltage level VL3 may be lower than the fourth voltage level VL4.

First to third reference levels VREF1 to VREF3 may be used to determine the amplitude of a symbol. The first reference level VREF1 may be lower than the second reference level VREF2, and the second reference level VREF2 may be lower than the third reference level VREF3. For example, the first reference level VREF1 may be used to distinguish between the first voltage level VL1 and the second voltage level VL2 and correspond to a middle or intermediate value between the first voltage level VL1 and the second voltage level VL2. The second reference level VREF2 may be used to distinguish between the second voltage level VL2 and the third voltage level VL3 and correspond to a middle or intermediate value between the second voltage level VL2 and the third voltage level VL3. In addition, the third reference level VREF3 may be used to distinguish between the third voltage level VL3 and the fourth voltage level VL4 and correspond to a middle or intermediate value between the third voltage level VL3 and the fourth voltage level VL4. The ADC 120 of FIG. 1 may generate input data X by sampling symbols at the center of the UI, i.e., at time t0.

Due to the above-described phenomena caused by the channel CH, the transmission signal TX may be distorted as it passes through the channel CH, and, accordingly, the receiver 100 may receive a reception signal RX that is different from the transmission signal TX. To compensate for signal distortion incurred due to the channel CH, an equalization or equalizing operation may be performed on the input data X generated by sampling the symbols.

FIG. 3 is a block diagram of an equalizer according to some implementations.

Referring to FIG. 3, the equalizer 130 may include a buffer circuit 131, a forward pass circuit 132, a backward pass circuit 133, and a merging circuit 134. The equalizer 130 of FIG. 3 is described in conjunction with FIG. 1, and descriptions already provided above are omitted here.

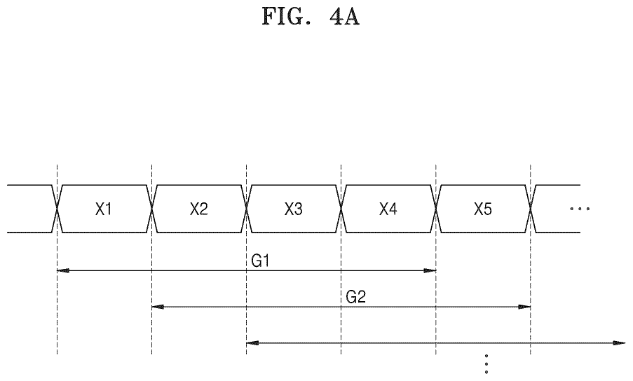

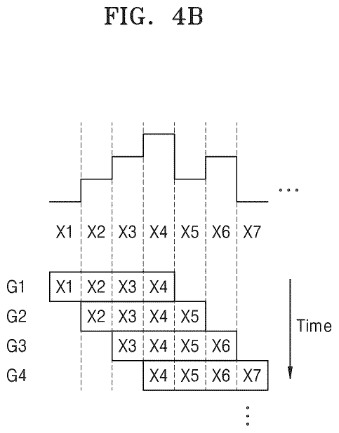

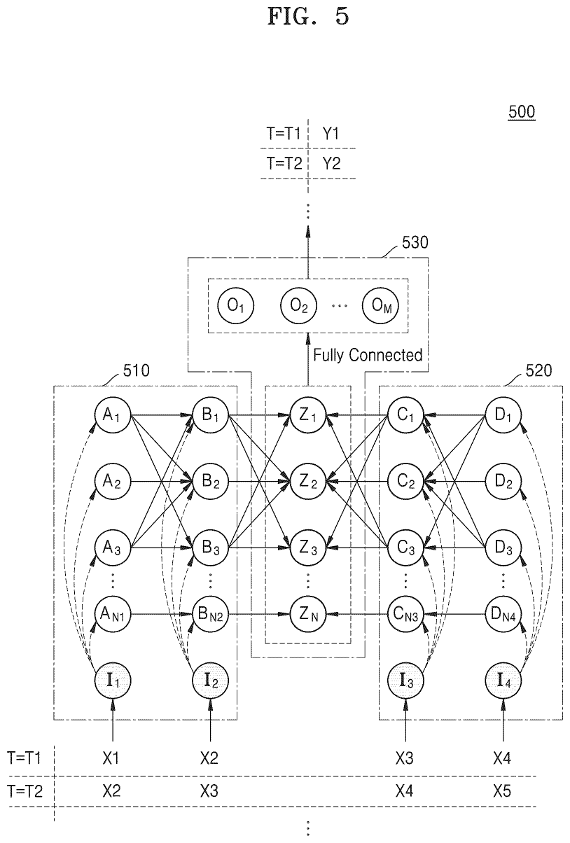

The buffer circuit 131 may store samples of the input data X input from the ADC 120. The input data X may include a plurality of samples generated by the ADC 120 performing sequential sampling on the analog input signal A. For example, a sample may be generated each time the ADC 120 samples the analog input signal A, and the plurality of generated samples may be referred to as the input data X. The input data X and the plurality of samples are described in detail with reference to FIGS. 4A, 4B, and 5.

The buffer circuit 131 may store sequentially-input samples and provide forward data XF and backward data XB respectively to the forward pass circuit 132 and the backward pass circuit 133. The buffer circuit 131 may store the samples. The buffer circuit 131 may transmit the generated forward data XF to the forward pass circuit 132 and transmit the generated backward data XB to the backward pass circuit 133.

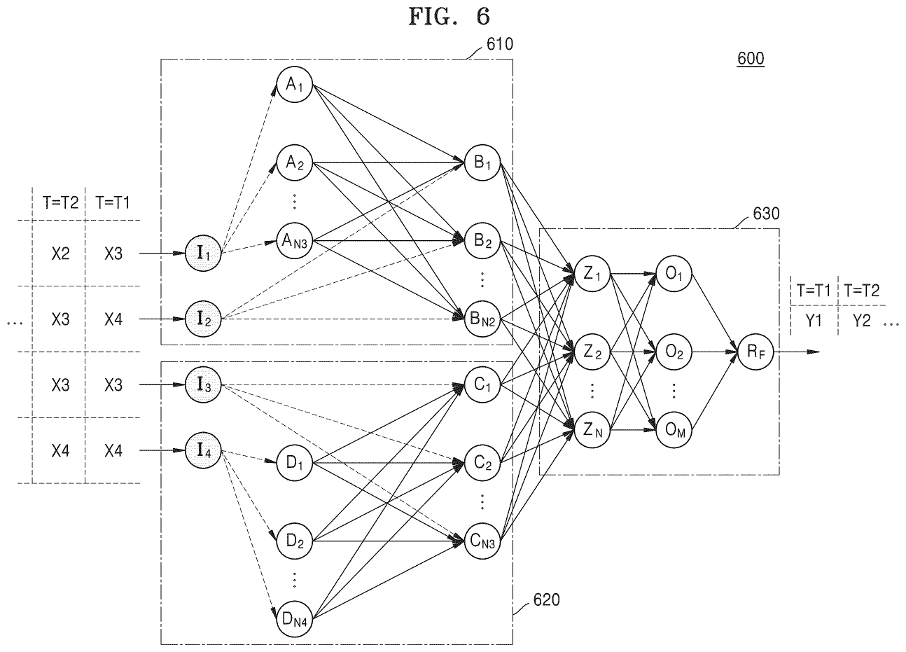

The forward pass circuit 132, the backward pass circuit 133, and the merging circuit 134 may each include an ANN structure. An ANN may refer to a computing device or a method performed by the computing device to implement interconnected sets of artificial neurons (or neuron models). An artificial neuron may generate output data by performing simple computations on input data, and the output data may be transmitted to other artificial neurons. As an example of an ANN, a deep neural network or deep learning may have a multi-layered structure. The ANN may include a plurality of layers, and each of the plurality of layers may be composed of a plurality of artificial neurons. An artificial neuron may be referred to as an artificial node or node, and, for example, the artificial neuron may be implemented as a PE. The ANN structures of the forward pass circuit 132, the backward pass circuit 133, and the merging circuit 134 are described in detail below with reference to FIGS. 6 to 8.

The forward pass circuit 132 may generate a forward output by performing inference on the forward data XF in a feedforward manner. A feedforward method may refer to a method of performing inferences according to an order in which samples are input. For example, the forward data XF may include a first sample and a second sample that are sequentially input. The first sample may include data from the reception signal RX that temporally precedes the second sample. The feedforward method may refer to a method in which inference is performed on the second sample after inference is performed on the first sample. The forward pass circuit 132 may generate the forward output and transmit the forward output to the merging circuit 134.

The backward pass circuit 133 may generate a backward output by performing inference on the backward data XB in a feedback manner. A feedback method may refer to a method of performing inferences in a reverse order to the input order of the samples. For example, the backward data XB may include a third sample and a fourth sample that are sequentially input. The third sample may include data from the reception signal RX that temporally precedes the fourth sample. The feedback method may refer to a method in which inference is performed on the third sample after inference is performed on the fourth sample. The backward pass circuit 133 may generate the backward output and transmit the backward output to the merging circuit 134.

The merging circuit 134 may perform inference on the forward output and backward output to generate equalized output data Y. Accordingly, the output data Y generated by the merging circuit 134 may be a result generated by performing inference on the input data X by using both the feedback method and the feedforward method. For example, the equalizer 130 may generate the output data Y by performing inference on the input data X by using both the feedback method and the feedforward method.

As described below, according to some implementations, the equalizer 130 may reduce a BER by accurately compensating for distortion of data signals that occurs during data transmission. In addition, the equalizer 130 may compensate for distortion of data signals that occurs during data transmission at high speed by compensating for distortion of sequentially input data, e.g., without a recursive circuit.

FIGS. 4A and 4B are diagrams illustrating input data input to an equalizer, according to some implementations. In detail, FIGS. 4A and 4B illustrate a series of samples generated by the ADC 120 sampling symbols. The ADC 120 may generate a series of samples by sampling symbols. Referring to FIGS. 4A and 4B, the series of samples may be a plurality of consecutive samples X1 to X5.

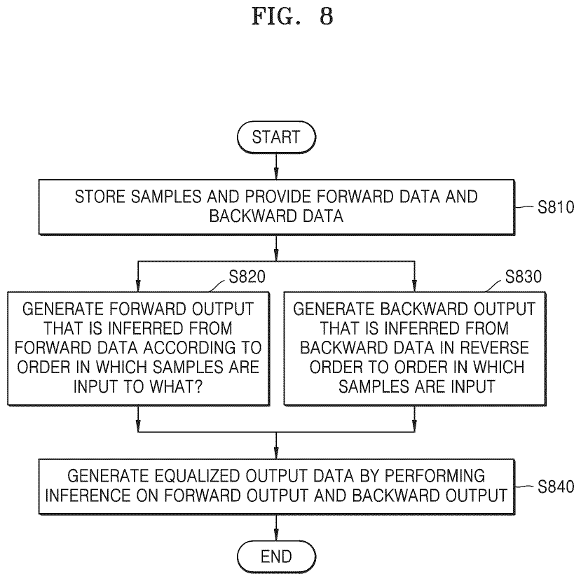

Input data X may include a plurality of samples generated sequentially. Symbol sampling may be performed continuously by the ADC 120 to thereby generate a series of samples. The input data X may include a certain number of samples among the series of samples. For example, referring to FIGS. 4A and 4B, the input data X may include 4 samples. Because the symbol sampling may be performed continuously by the ADC 120, the input data X may also include different samples over time. For example, at a first time, the input data X may include a first sample set G1. For example, at the first time, the input data X may include a plurality of samples X1 to X4. Then, at a second time, the input data X may include a second sample set G2. For example, at the second timing, the input data X may include a plurality of samples X2 to X5. While the input data X is illustrated as including 4 samples, this is only an example, and the input data X may include a different number of samples. As described below, FIG. 8 illustrates an example in which the equalizer 130 receives input data X including 5 samples.

As shown in FIG. 5, at a third time, the input data X may include a third sample set G3 including a plurality of samples X3 to X6. At a fourth time, the input data X may include a sourth sample set GG4 including a plurality of samples X4 to X7.

As described below, samples included in the input data X may be divided into forward data XF and backward data XB as the samples pass through the buffer circuit 131. For example, when the input data X includes the plurality of samples X1 to X4, the plurality of samples X1 to X4 may be divided into forward data XF including the plurality of samples X1 and X2 and backward data XB including the plurality of samples X3 and X4 as they pass through the buffer circuit 131. However, this is only an example, and the forward data XF and the backward data XB may include different numbers of samples than described above.

FIG. 5 is a diagram illustrating an ANN structure within an equalizer, according to some implementations. Referring to FIG. 5, an equalizer 500 may include a forward pass circuit 510, a backward pass circuit 520, and a merging circuit 530. The forward pass circuit 510, the backward pass circuit 520, and the merging circuit 530 may each include an ANN structure. Although not shown in FIG. 5, the equalizer 500 may further include a buffer circuit and receive input data X including a plurality of samples from the buffer circuit, e.g., as shown in FIG. 3. The equalizer 500 of FIG. 5 may be an example of the equalizer 130 of FIGS. 1 and 3. The equalizer 500 of FIG. 5 is described in conjunction with the above-described example, and descriptions already provided above are omitted here.

The forward pass circuit 510, the backward pass circuit 520, and the merging circuit 530 may each include an ANN structure, each ANN may include a plurality of layers, and each of the plurality of layers may be composed of a plurality of artificial neurons. Each of the layers included in the ANN may include a plurality of artificial nodes, known as neurons, units, or similar terms. Each of the layers included in the ANN may include a various number of nodes, and the number of nodes included in each layer may vary. Nodes respectively included in the layers in the ANN may be connected to each other to exchange data with each other. For example, each node may receive data from other nodes, perform computations, and output a result of the computations to the other nodes.

An input and an output of each node may be referred to as an activation or output. An activation may be an output value of each node and an input value fed to nodes in the next layer. Moreover, each node may determine its own activation, based on activations received from nodes included in the previous layer and weights. A weight is a network parameter used to calculate an activation at each node and may be a value assigned to a connection relationship between nodes. Nodes may determine their own activations based on activations received from the previous layer, weights, and biases. Each node may be a computational unit that receives an input and outputs an activation and may map an input to an output.

An ANN may include an activation function between layers. The activation function may transform an output of the previous layer into an input to the next layer. For example, the activation function may be a non-linear function, such as rectified linear unit (ReLU), parametric ReLU (PReLU), hyperbolic tangent (tanh), or sigmoid function, and may non-linearly transform an output from the preceding layer between layers. An activation may be a value obtained by applying an activation function to a weighted sum of activations received from the previous layer.

Referring to FIG. 5, according to some implementations, the equalizer 500 may receive input data X including multiple samples (in this example, four samples). The buffer circuit may match the timing of the four samples included therein and provide the four samples as forward data XF and backward data XB. For example, at first timing T1, the input data X may include four samples, e.g., first to fourth samples X1 to X4. The forward data XF may include the first sample X1 and the second sample X2, and the backward data XB may include the third sample X3 and the fourth sample X4. Also, at second timing T2, the input data X may include four samples, e.g., second to fifth samples X2 to X5. The forward data XF may include the second sample X2 and the third sample X3, and the backward data XB may include the fourth sample X4 and the fifth sample X5. However, this is only an example, and the input data X including a different number of samples may be received. The samples input at the first timing T1 are hereinafter described as an example, but it should be noted that different samples may be sequentially input over time.

The forward pass circuit 510 may include input nodes I₁ and I₂, a first layer, and a second layer. The first layer may include N1 nodes A₁ to A_{N1} (where N1 is a natural number greater than or equal to 2), and the second layer may include N2 nodes B₁ to B_{N2} (where N2 is a natural number greater than or equal to 2). The input node I₁ may transmit the first sample X1 to the first layer inside. The first layer may generate a first output by performing inference on the first sample X1 and transmit the first output to the second layer. The input node I₂ may transmit the second sample X2 to the second layer inside. The second layer may generate a second output inferred from the second sample X2 and the first output and transmit the second output to the merging circuit 530. The second output may be an output of the forward pass circuit 510 and may be referred to as a forward output.

The backward pass circuit 520 may include input nodes I₃ and I₄, a third layer, and a fourth layer. The third layer may include N3 nodes C₁ to C_{N3} (where N3 is a natural number greater than or equal to 2), and the fourth layer may include N4 nodes D₁ to D_{N4} (where N4 is a natural number greater than or equal to 2). The input node I₃ may transmit the third sample X3 to the third layer inside. The input node I₄ may transmit the fourth sample X4 to the fourth layer inside. The fourth layer may generate a fourth output inferred from the fourth sample X4 and transmit the fourth output to the third layer. The third layer may generate a third output inferred from the third sample X3 and the fourth output and transmit the third output to the merging circuit 530. The third output may be an output of the backward pass circuit 520 and may be referred to as a backward output.

The forward pass circuit 510 may perform inference on the second sample X2 along with a result of inference performed on the first sample X1, thereby performing inferences in a feedforward manner. The backward pass circuit 510 may perform inference on the third sample X3 along with a result of inference performed on the fourth sample X4, thereby performing inferences in a feedback manner. Furthermore, samples input to the equalizer 500 may pass through different numbers of layers depending on a path of the input samples. For example, the first sample X1 may pass through both the first layer and the second layer, but the second sample X2 may pass directly through the second layer without passing through the first layer. In addition, the fourth sample X4 may pass through both the fourth layer and the third layer, but the third sample X3 may pass directly through the third layer without passing through the fourth layer. Through this, the equalizer 500 may form a different layer depth for each input sample.

The merging circuit 530 may include a merge layer and an output layer. The merge layer may include N nodes Z₁ to Z_{N} (where N is a natural number greater than or equal to 2), and the output layer may include M nodes O₁ to O_{M} (where M is a natural number greater than or equal to 2). The merge layer may pass an output inferred from the forward output and the backward output to the output layer. The output layer may finally generate equalized output data Y. For convenience of illustration, a connection relationship between the merge layer and the output layer is not shown in FIG. 5, but the merge layer and the output layer may be fully connected to each other. Because the output is inferred by merging the forward output and the backward output in the merge layer, the equalizer 130 may generate output data Y by performing inference on the input data X by using both a feedback method and a feedforward method. The merging circuit 530 may generate output data Y1 corresponding to the first to fourth samples X1 to X4 input at the first timing T1. The merging circuit 530 may generate output data Y2 corresponding to the second to fifth samples X2 to X5 input at the second timing T2.

In some implementations, the number M of M nodes O₁ to O_{M} constituting the output layer may be determined by the number of signal levels in a signaling scheme used by the transmitter 200. For example, when the transmitter 200 uses a PAM-4 scheme, the number M of the M nodes O₁ to O_{M} constituting the output layer may be 4. Also, when the transmitter 200 uses an NRZ scheme, the number M of the M nodes O₁ to O_{M} constituting the output layer may be 2.

According to some implementations, the equalizer 500 may accurately compensate for distortion of data signals that occurs during data transmission, thereby achieving reduction in a BER. In addition, the equalizer 500 may compensate for distortion of data signals that occurs during data transmission at high speed by compensating for distortion of sequentially input data without a recursive circuit.

FIG. 6 is a diagram illustrating an ANN structure within an equalizer, according to some implementations. Referring to FIG. 6, an equalizer 600 may include a forward pass circuit 610, a backward pass circuit 620, and a merging circuit 630. The forward pass circuit 610, the backward pass circuit 620, and the merging circuit 630 may each include an ANN structure. The equalizer 600 of FIG. 6 may be an example of the equalizer 130 of FIGS. 1 and 3. The equalizer 600 of FIG. 6 may be an example of the equalizer 500 of FIG. 5. The equalizer 600 of FIG. 6 is described in conjunction with the above-described examples, and descriptions already provided above are omitted here.

The equalizer 600 of FIG. 6 may have an ANN structure obtained by rearranging the internal ANN structure of the equalizer 500 of FIG. 5 according to layers. For example, the forward pass circuit 610, the backward pass circuit 620, and the merging circuit 630 of FIG. 6 may respectively correspond to the forward pass circuit 510, the backward pass circuit 520, and the merging circuit 530 of FIG. 5.

The forward pass circuit 610 may perform inference on the second sample X2 along with a result of inference performed on the first sample X1, thereby performing inference in a feedforward manner. The backward pass circuit 620 may perform inference on the third sample X3 along with a result of inference performed on the fourth sample X4, thereby performing inference in a feedback manner.

Furthermore, samples input to the equalizer 600 may pass through different numbers of layers depending on a path of the input samples. For example, the first sample X1 may pass through both the first layer and the second layer, but the second sample X2 may pass directly through the second layer without passing through the first layer. In addition, the fourth sample X4 may pass through both the fourth layer and the third layer, but the third sample X3 may pass directly through the third layer without passing through the fourth layer. Through this, the equalizer 600 may form a different layer depth for each input sample.

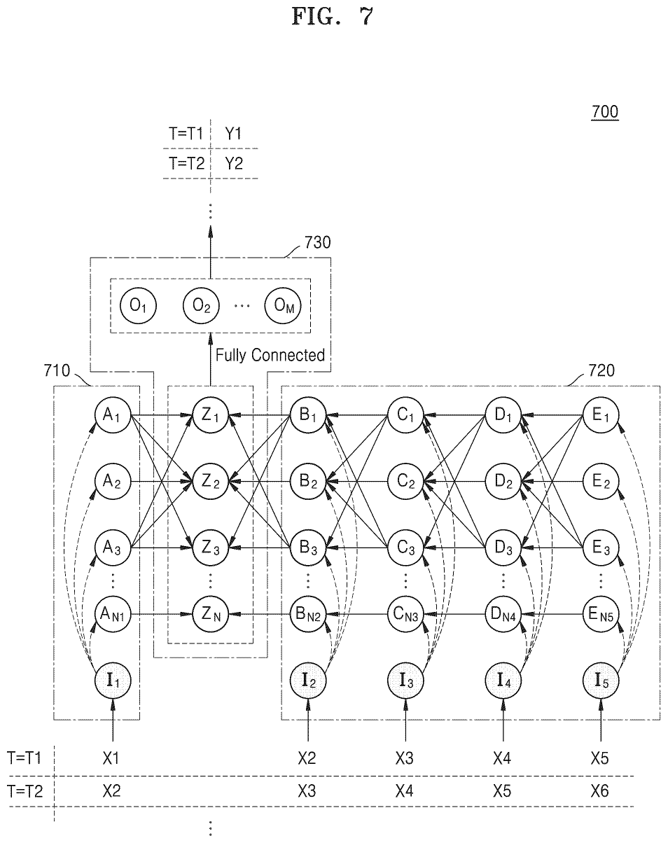

FIG. 7 is a diagram illustrating an ANN structure within an equalizer, according some implementations. Referring to FIG. 7, an equalizer 700 may include a forward pass circuit 710, a backward pass circuit 720, and a merging circuit 730. The forward pass circuit 710, the backward pass circuit 720, and the merging circuit 730 may each include an ANN structure. Although not shown in FIG. 7, the equalizer 700 may further include a buffer circuit (e.g., as shown in FIG. 3), and receive, from the buffer circuit, input data X including a plurality of samples with matched timings. The equalizer 700 of FIG. 7 may be an example of the equalizer 130 of FIGS. 1 and 3. The equalizer 700 of FIG. 7 is described in conjunction with the above-described examples, and descriptions already provided above are omitted herein.

Referring to FIG. 7, according to some implementations, the equalizer 700 may receive input data X including five samples. The buffer circuit may match the timings of the five samples included therein and provide the four samples as forward data XF and backward data XB. For example, at first timing T1, the input data X may include five samples, e.g., first to fifth samples X1 to X5. The forward data XF may include the first sample X1, and the backward data XB may include a plurality of samples, e.g., the second to fifth samples X2 to X5. Also, at second timing T2, the input data X may include five samples, e.g., second to sixth samples X2 to X6. The forward data XF may include the second sample X2, and the backward data XB may include a plurality of samples, e.g., third to sixth samples X3 to X6. The samples input at the first timing T1 are hereinafter described as an example, but it should be noted that different samples may be sequentially input over time. As illustrated in FIG. 7, the forward data XF and the backward data XB may include different numbers of samples.

The forward pass circuit 710 may include an input node I₁ and a first layer. The first layer may include N1 nodes A₁ to A_{N1}. The input node I₁ may transmit the first sample X1 to the first layer inside the forward pass circuit 710. The first layer may generate a first output inferred from the first sample X1 and transmit the first output to the merging circuit 730. The first output may be an output of the forward pass circuit 710 and may be referred to as a forward output.

The backward pass circuit 720 may include input nodes I₂ and I₅ and second to fifth layers. The third layer may include N2 nodes B₁ to B_{N2} (where N2 is a natural number greater than or equal to 2), and the third layer may include N3 nodes C₁ to C_{N3} (where N3 is a natural number greater than or equal to 2). The fourth layer may include N4 nodes D1 to D_{N4} (where N4 is a natural number greater than or equal to 2), and the fifth layer may include N5 nodes E₁ to E_{N5} (where N5 is a natural number greater than or equal to 2). The input node I₂ may transmit the second sample X2 to the second layer inside the backward pass circuit 720, and the input node I₃ may transmit the third sample X3 to the third layer inside. The input node I₄ may transmit the fourth sample X4 to the fourth layer inside, and the input node I₅ may transmit the fifth sample X5 to the fifth layer inside. The fifth layer may generate a fifth output inferred from the fifth sample X5 and transmit the fifth output to the fourth layer. The fourth layer may generate a fourth output inferred from the fourth sample X4 and the fifth output and transmit the fourth output to the third layer. The third layer may generate a third output inferred from the third sample X3 and the fourth output and transmit the third output to the second layer. The second layer may generate a second output inferred from the second sample X2 and the third output and transmit the second output to the merging circuit 730. The second output may be an output of the backward pass circuit 720 and may be referred to as a backward output.

The merging circuit 730 may include a merge layer and an output layer. The merge layer may include N nodes Z₁ to Z_{N} (where N is a natural number greater than or equal to 2), and the output layer may include M nodes O₁ to O_{M} (where M is a natural number greater than or equal to 2). The merge layer may pass an output inferred from the forward output and the backward output to the output layer. The output layer may finally generate equalized output data Y. For convenience of illustration, a connection relationship between the merge layer and the output layer is not shown in FIG. 7, but the merge layer and the output layer may be fully connected to each other. Because the output is inferred by merging the forward output and the backward output in the merge layer, the equalizer 700 may generate output data Y by performing inference on the input data X by using both a feedback method and a feedforward method. The merging circuit 730 may generate output data Y1 corresponding to the first to fifth samples X1 to X5 input at the first timing T1. The merging circuit 730 may generate output data Y2 corresponding to the second to sixth samples X2 to X6 input at the second timing T2.

According to some implementations, the equalizer 700 may accurately compensate for distortion of data signals that occurs during data transmission, thereby achieving reduction in a BER. In addition, the equalizer 700 may compensate for distortion of data signals that occurs during data transmission at high speed by compensating for distortion of sequentially input data without a recursive circuit.

FIG. 8 is a flowchart of an operating method of an equalizer, according to some implementations.

Referring to FIG. 8, the operating method of the equalizer (e.g., equalizer 130 of FIGS. 1 and 3, and/or equalizer 500, 600, or 700 of FIGS. 5, 6, and 7, respectively) may include a plurality of operations S810 to S840. The operating method illustrated in FIG. 8 is hereinafter described in conjunction with the above figures, and descriptions already provided above are omitted herein. Moreover, although the operating method is described with respect to the equalizer 130, its application is not limited thereto

The equalizer 130 may sequentially receive digitized samples from the ADC 120. For example, the equalizer 130 may receive samples via the buffer circuit 131. According to some implementations, the equalizer 130 may receive a plurality of samples X1 to X4 from the ADC 120. It is noted that the number of the received plurality of samples may vary.

In operation S810, the equalizer 130 may store samples and provide forward data XF and backward data XB. By storing the samples, the buffer circuit 131 may synchronize the timings of a plurality of samples constituting the input data X. The buffer circuit 131 may transmit the generated forward data XF to the forward pass circuit 132 and transmit the generated backward data XB to the backward pass circuit 133.

In operation S820, the equalizer 130 may generate a forward output by performing inference from the forward data XF in a feedforward manner according to an order in which samples are input. For example, the forward data XF may include a first sample and a second sample that are sequentially input. The first sample may include data from a reception signal RX that temporally precedes the second sample. The feedforward method may refer to a method in which inference is performed on the second sample after inference is performed on the first sample. The forward pass circuit 132 may generate the forward output and transmit it to the merging circuit 134.

In operation S830, the equalizer 130 may generate a backward output by performing inference from the backward data XB in a feedback manner in a reverse order to the input order of the samples. For example, the backward data XB may include a third sample and a fourth sample that are sequentially input. The third sample may include data from the reception signal RX that temporally precedes the fourth sample. The feedback method may refer to a method in which inference is performed on the third sample after inference is performed on the fourth sample. The backward pass circuit 133 may generate the backward output and transmit it to the merging circuit 134. Operation S820 and operation S830 may be performed at least partially in parallel.

In operation S840, the equalizer 130 may generate equalized output data Y from the forward output and the backward output. Accordingly, the output data Y generated by the merging circuit 134 may be a result generated by performing inference on the input data X by using both the feedback method and the feedforward method. For example, the equalizer 130 may infer the input data X by using both the feedback method and the feedforward method to thereby generate the output data Y.

According to some implementations, based on the process of FIG. 8 and other processes discussed herein, the equalizer 130 may accurately compensate for distortion of data signals that occurs during data transmission, thereby achieving reduction in a BER. In addition, the equalizer 130 may compensate for distortion of data signals that occurs during data transmission at high speed by compensating for distortion of sequentially input data without a recursive circuit.

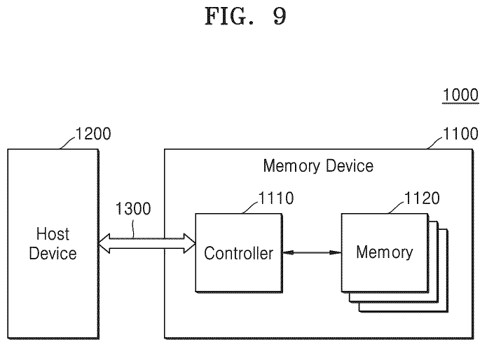

FIG. 9 is a block diagram of a system 1000 including an equalizer, according to some implementations. Referring to FIG. 9, a memory device 1100 may communicate with a host device 1200 via an interface 1300 and include a controller 1110 and a memory 1120.

The interface 1300 may use electrical signals and/or optical signals and as a non-limiting example, may be implemented as a serial advanced technology attachment (SATA) interface, a SATA express (SATAe) interface, a serial attached small computer system interface (or serial attached SCSI) (SAS), a universal serial bus (USB) interface, or a combination thereof.

In some implementations, the memory device 1100 may be removably coupled to the host device 1200 to communicate with the host device 1200. The memory 1120 may be a non-volatile memory, and the memory device 1100 may also be referred to as a storage system. For example, as a non-limiting example, the memory device 1100 may be implemented as a solid-state drive or solid-state disk (SSD), an embedded SSD (eSSD), a multimedia card (MMC), an embedded MMC (eMMC), or the like. The controller 1110 may control the memory 1120 in response to a request received from the host device 1200 through the interface 1300.

In some implementations, the memory device 1100 that communicates with the host device 1200 via the interface 1300 may include the equalizer 130 (or another equalizer described herein, such as the equalizer of any of FIGS. 5-7) therein. The memory device 1100 may quickly and accurately compensate for distortion of a data signal that occurs during data transmission via the equalizer 130.

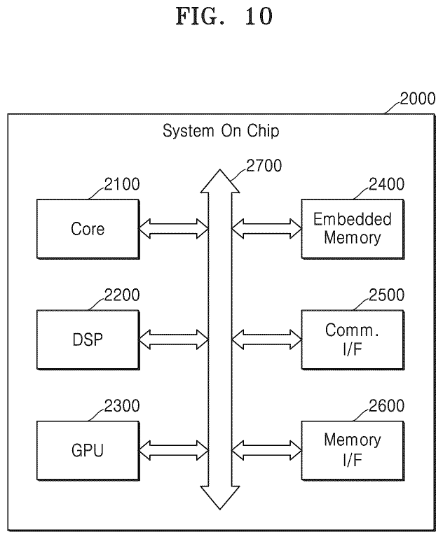

FIG. 10 is a block diagram of a system-on-chip (SoC) including an equalizer, according to some implementations. Referring to FIG. 10, an SoC 2000 may refer to an integrated circuit that integrates components of a computing system or other electronic systems. For example, an application processor (AP) that is a type of the SoC 2000 may include a processor and components having other functions. Referring to FIG. 10, the SoC 2000 may include a core 2100, a digital signal processor (DSP) 2200, a graphics processing unit (GPU) 2300, an embedded memory 2400, a communication interface 2500, and a memory interface 2600. Components of the SoC 2000 may communicate with one another via a bus 2700.

The core 2100 may process instructions and control operations of the components included in the SoC 2000. For example, by processing a series of instructions, the core 2100 may run an operating system and execute applications on the operating system. The DSP 2200 may generate effective data by processing digital signals such as digital signals provided from the communication interface 2500. The GPU 2300 may generate data for an image output on a display device based on image data provided from the embedded memory 2400 or the memory interface 2600, or encode the image data. The embedded memory 2400 may store data necessary for the core 2100, the DSP 2200, and the GPU 2300 to operate. The memory interface 2600 may provide an interface to an external memory of the SoC 2000, such as dynamic random access memory (DRAM), flash memory, etc.

The communication interface 2500 may provide communication with components external to the SoC 2000. For example, the communication interface 2500 may be connected to Ethernet and include SerDes for serial communication.

The communication interface 2500 may include the equalizer 130 (or another equalizer described herein, such as the equalizer of any of FIGS. 5-7). Thus, the communication interface 2500 may compensate for distortion in data via the equalizer 130 during communication with the outside. Accordingly, the communication interface 2500 may quickly and accurately compensate for distortion of a data signal that occurs during data transmission.

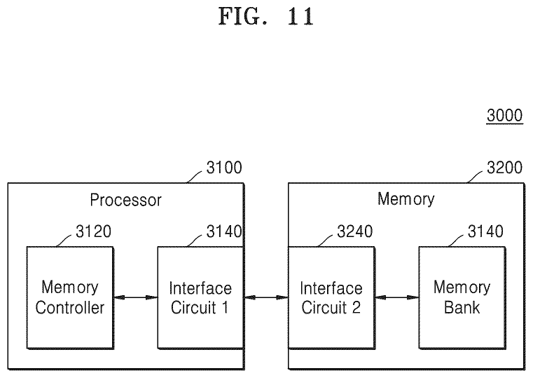

FIG. 11 is a block diagram of a system including an equalizer, according to some implementations. Referring to FIG. 11, a system 3000 may include a processor 3100 and a memory 3200. For example, the system 3000 may be one of various computing devices such as a desktop computer, a laptop computer, a workstation, a server, a smartphone, a tablet personal computer (PC), a digital camera, a black box, etc.

The processor 3100 may control all operations of the system 3000. For example, the processor 3100 may be an AP configured to control all operations of the system 3000. The processor 3100 may execute an operating system, programs, or applications running on the system 3000. For example, the processor 3100 may include intellectual property (IP) blocks for controlling various operations of the system 3000 or various components included in the system 3000.

The processor 3100 may store data in the memory 3200 or read data stored in the memory 3200. For example, the processor 3100 may include a memory controller 3120 and a first interface circuit 3140. The memory controller 3120 may be configured to control the memory 3200 via the first interface circuit 3140. The first interface circuit 3140 may also be referred to as a physical layer (PHY).

According to control by the memory controller 3120, the first interface circuit 3140 may transmit a clock signal, a write clock signal, and a command/address signal to the memory 3200 and exchange data signals with the memory 3200. For example, the first interface circuit 3140 may be a double data rate (DDR)-PHY configured to support a DDR interface. That is, the first interface circuit 3140 may be configured to support various standard interfaces such as DDR, graphics DDR (GDDR), low-power DDR (LPDDR), etc. defined by the Joint Electronic Device Engineering Council (JEDEC) standard, but the scope of interfacing method is not limited thereto.

The memory 3200 may operate under the control by the processor 3100. For example, the memory 3200 may receive a clock signal and a command/address signal from the processor 3100 and, in response to the received signals, transmit data to the processor 3100 via a data signal or receive data from the processor 3100 via a data signal and a write clock signal. For example, the memory 3200 may include a second interface circuit 3240 and a memory bank 3220. The second interface circuit 3240 may also be referred to as a PHY. The second interface circuit 3240 may control, based on internal control signals, a write operation for storing data in the memory bank 3220 and a read operation for reading data from the memory bank 3220.

For example, the memory 3200 may be a DRAM device, but the type of memory is not limited thereto. For example, the memory 3200 may include at least one of various types of memory devices, such as a DRAM device, a static RAM (SRAM) device, a resistive RAM (RRAM) device, a ferroelectric RAM (FRAM) device, a phase change RAM (PRAM) device, a magnetic RAM (MRAM) device, and a flash memory device.

At least one of the first interface circuit 3140 and the second interface circuit 3240 may include the equalizer 130 (or another equalizer described herein, such as the equalizer of any of FIGS. 5-7). Thus, the first interface circuit 3140 and the second interface circuit 3240 may compensate for distortions in data via the equalizer 130 while communicating with each other. As a result, the memory 3200 or the processor 3100 may quickly and accurately compensate for distortion in data signals that occurs during data transmission.

According to some implementations, the equalizer 130 may accurately compensate for distortion of data signals that occurs during data transmission, thereby achieving reduction in a BER. In addition, the equalizer 130 may compensate for distortion of data signals that occurs during data transmission at high speed by compensating for distortion of sequentially input data without a recursive circuit.

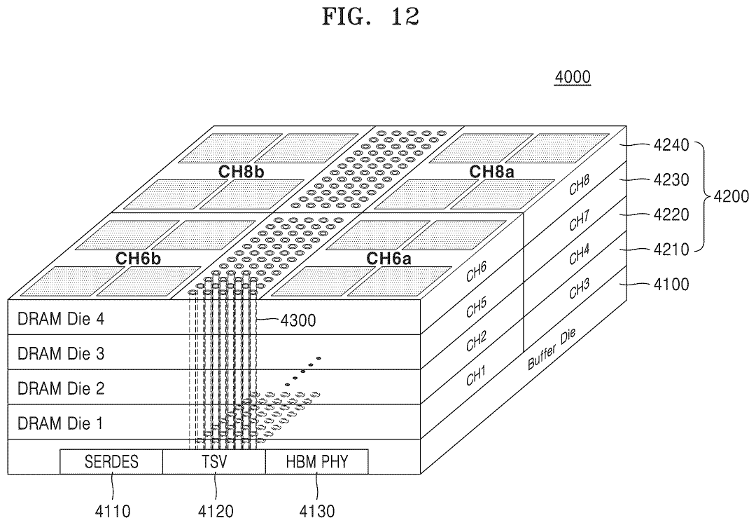

FIG. 12 illustrates a memory device to which an equalizer, such as the equalizer 130 or the equalizers 500, 600, or 700 of FIGS. 5-7, may be applied.

Referring to FIG. 12, a memory device 4000 may be a high bandwidth memory (HBM) including a plurality of channels, e.g., first to eighth channels CH1 to CH8, having interfaces independent of one another. The memory device 4000 may include a plurality of dies including a buffer die 4100 and a plurality of DRAM dies 4200 stacked on the buffer die 4100. For example, a first DRAM die 4210 may include the first channel CH1 and the third channel CH3, a second DRAM die 4220 may include the second channel CH2 and the fourth channel CH4, a third DRAM die 4230 may include the fifth channel CH5 and the seventh channel CH7, and a fourth DRAM die 4240 may include the sixth channel CH6 and the eighth channel CH8.

The buffer die 4100 may communicate with a processor, such as the processor 3100, through conductive elements, such as bumps or solder balls, formed on an outer surface of the memory device 4000. The buffer die 4100 may receive commands, addresses, and data from the processor 3100 and provide the received commands, addresses, and data to channels of at least one of the DRAM dies 4200. The buffer die 4100 may also provide data output from the channels of the plurality of DRAM dies 4200 to the processor 3100.

The memory device 4000 may include a plurality of through silicon vias (TSVs) 4300 penetrating the plurality of DRAM dies 4200. When each of the first to eighth channel CH1 to CH8 has a 128-bit bandwidth, the TSVs 4300 may include components for inputting and outputting 1024 bits of data. Each of the first to eighth channels CH1 to CH8 may be arranged separately on the left and right, for example, in the fourth DRAM die 4240, the sixth channel CH6 may be divided into pseudo channels CH6a and CH6b, and the eighth channel CH8 may be divided into pseudo channels CH8a and CH8b. The TSVs 4300 may be arranged between the pseudo channels CH6a and CH6b of the sixth channel CH6 and between the pseudo channels CH8a to CH8b of the eighth channel CH8.

The buffer die 4100 may include a TSV region 4120, a serializer/deserializer (SERDES) region 4110, and an HBM PHY interface, e.g., an HBM PHY region 4130. The TSV region 4120 may be a region where the TSVs 4300 are formed for communication with the plurality of DRAM dies 4200.

The SERDES region 4110 may be a region that provides a SERDES interface of the JEDEC standard as the processing throughput of the processor 3100 increases and as demands for memory bandwidth increase. The SERDES region 4110 may include a SERDES transmitter portion, a SERDES receiver portion, and a controller portion. The SERDES transmitter portion may include a parallel-to-serial conversion circuit and a transmitter, and receive a parallel data stream and serialize the received parallel data stream. The SERDES receiver portion may include a receiver amplifier, an equalizer, a clock and data recovery (CDR) circuit, and a serial-to-parallel conversion circuit and receive a serial data stream and convert the received serial data stream into a parallel data stream. The controller portion may include registers such as an error detection circuit, an error correction circuit, and a first-in first-out (FIFO) register.

The HBM PHY region 4130 may include a physical or electrical layers and a logical layer that are provided for signals, frequency, timing, driving, detailed operating parameters, and functionality required for efficient communication between the processor 3100 and the memory device 4000. The HBM PHY region 4130 may perform memory interfacing, such as selecting rows and columns corresponding to memory cells, writing data to the memory cells, or reading the written data. The HBM PHY region 4130 may support features of an HBM protocol defined by the JEDEC standard.

The memory device 4000 of FIG. 12 may be an example of the memory 3200 of FIG. 12. For example, the memory 3200 may be an HBM including multiple channels (e.g., CH1 to CH8) having independent interfaces.

The buffer die 4100 may include the equalizer 130 or another equalizer described herein, such as the equalizer of any of FIGS. 5-7. Thus, the buffer die 4100 may compensate for distortion in data via the equalizer 130 during communication with the processor 3100. Accordingly, the buffer die 4100 may quickly and accurately compensate for distortion of a data signal that occurs during data transmission.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Examples have been set forth above in the drawings and specification. It will be understood by one of ordinary skill in the art that various changes and equivalent other examples are possible therefrom. Thus, the technical scope of the inventive concept will be determined by the appended claims.

What is claimed is:

1. An equalizer comprising:
a buffer circuit configured to receive samples having a sequential order and to provide the samples as forward data and backward data;
a forward pass circuit configured to generate a forward output by performing inference on the forward data in a feedforward manner with respect to the sequential order;
a backward pass circuit configured to generate a backward output by performing inference on the backward data in a feedback manner using a reverse order to sequential order; and
a merging circuit configured to generate equalized output data based on the forward output and the backward output.

2. The equalizer of claim 1, wherein the samples include a first sample and a second sample that is after the first sample in the sequential order,
wherein the buffer circuit is configured to generate the forward data including the first sample and the second sample, and
wherein the forward pass circuit comprises:
a first neural network layer configured to receive the first sample and generate a first output inferred from the first sample; and
a second neural network layer configured to generate a second output inferred from the second sample and the first output.

3. The equalizer of claim 2, wherein a number of processing units in the first neural network layer is different from a number of processing units in the second neural network layer.

4. The equalizer of claim 1, wherein the samples include a third sample and a fourth sample that is after the third sample in the sequential order,
wherein the buffer circuit is configured to generate the backward data including the third sample and the fourth sample, and
wherein the backward pass circuit comprises:
a fourth neural network layer configured to receive the fourth sample and generate a fourth output inferred from the fourth sample; and
a third neural network layer configured to generate a third output inferred from the third sample and the fourth output.

5. The equalizer of claim 4, wherein a number of processing units in the third neural network layer is different from a number of processing units in the fourth neural network layer.

6. The equalizer of claim 1, wherein the forward pass circuit and the backward pass circuit comprise different numbers of artificial neural network layers.

7. The equalizer of claim 1, wherein the forward pass circuit and the backward pass circuit each comprise a first layer and a second layer forming an artificial neural network structure, and
wherein a number of processing units in the first layer is different from a number of processing units in the second layer.

8. The equalizer of claim 1, wherein the samples are generated from a signal having a signaling scheme using N signal levels (where N is a natural number greater than or equal to 2), and
wherein the merging circuit comprises a final neural network layer having N processing units, the final neural network layer configured to generate the output data.

9. An equalization method comprising:
receiving, in a sequential order, samples that are in a digital form, the samples received from an analog-to-digital converter;
providing the samples as forward data and backward data;
generating a forward output by performing inference on the forward data in a feedforward manner with respect to the sequential order;
generating a backward output by performing inference on the backward data in a feedback manner using a reverse order to the sequential order; and
generating equalized output data based on the forward output and the backward output.

10. The method of claim 9, wherein the samples include a first sample and a second sample, wherein the first sample is received before the second sample in the sequential order,
wherein providing the forward data and the backward data comprises generating the forward data including the first sample and the second sample, and
wherein generating the forward output comprises:
receiving the first sample and generating a first output inferred from the first sample; and
generating a second output inferred from the second sample and the first output.

11. The method of claim 9, wherein the samples include a third sample and a fourth sample, wherein the third sample is received before the fourth sample in the sequential order,
wherein providing the forward data and the backward data comprises generating the forward data including the third sample and the fourth sample, and
wherein generating the forward output comprises:
receiving the fourth sample and generating a fourth output inferred from the fourth sample; and
generating a third output inferred from the third sample and the fourth output.

12. The method of claim 9, wherein the samples include a first sample and a second sample,
wherein the equalizer comprises a first neural network layer and a second neural network layer configured to form a neural network structure,
wherein generating the forward output or generating the backward output comprises providing the first sample as input to the first neural network layer and providing the second sample as input to the second neural network layer, and
wherein a number of processing units in the first neural network layer is different from a number of processing units in the second neural network layer.

13. The method of claim 9, wherein the samples are generated from a signal having a signaling scheme using N signal levels (where N is a natural number greater than or equal to 2), and
wherein the equalizer comprises a final neural network layer having N processing units, the final neural network layer configured to generate the output data.

14. A receiver comprising:
an input amplifier configured to amplify an input signal and output an amplified input signal;
an analog-to-digital converter configured to generate, based on the amplified input signal, samples that are in a digital form; and
an equalizer including a neural network structure, the equalizer configured to generate equalized output data based on the samples received at the equalizer in a sequential order,
wherein the equalizer is configured to
provide forward data and backward data including the samples,
generate a forward output by performing inference on the forward data in a feedforward manner with respect to the sequential order,
generate a backward output by performing inference on the backward data in a feedback manner using a reverse order to the sequential order, and
generate equalized output data based on the forward output and the backward output.

15. The receiver of claim 14, wherein the samples include a first sample and a second sample is received at the equalizer after the first sample,
wherein the equalizer is configured to generate the forward data including the first sample and the second sample,
wherein the neural network structure comprises a first neural network layer configured to receive the first sample and generate a first output inferred from the first sample, and
wherein the neural network structure comprises a second neural network layer configured to generate a second output inferred from the second sample and the first output.

16. The receiver of claim 15, wherein a number of processing units in the first neural network layer is different from a number of processing units in the second neural network layer.

17. The receiver of claim 14, wherein the samples include a third sample and a fourth sample that is received at the equalizer after the fourth sample,
wherein the equalizer is configured to generate the backward data including the third sample and the fourth sample,
wherein the neural network structure comprises a fourth neural network layer configured to receive the fourth sample and generate a fourth output inferred from the fourth sample, and
wherein the neural network structure comprises a third neural network layer configured to generate a third output inferred from the third sample and the fourth output.

18. The receiver of claim 17, wherein a number of processing units in the third neural network layer is different from a number of processing units in the fourth layer.

19. The receiver of claim 14, wherein the samples are generated from a signal having a signaling scheme using N signal levels (where N is a natural number greater than or equal to 2), and
wherein the equalizer comprises a final neural network layer having N processing units, the final neural network layer configured to generate the output data.

20. The receiver of claim 14, wherein the equalizer comprises:
a buffer circuit configured to store the samples and provide the forward data and the backward data;
a forward pass circuit configured to generate the forward output;
a backward pass circuit configured to generate the backward output; and
a merging circuit configured to generate the equalized output data based on the forward output and the backward output.
